(19) United States
(12) Patent Application Publication
(10) Pub. No.: US 2026/0164317 A1
(43) Pub. Date: Jun. 11, 2026

(54) ENHANCED UAV MEASUREMENT REPORTS

(71) Applicant: Apple Inc., Cupertino, CA (US)

(72) Inventors: Yuqin CHEN, Beijing (CN); Fangli XU, Beijing (CN); Haijing HU, Los Gatos, CA (US)

(21) Appl. No.: 19/126,955

(22) PCT Filed: Oct. 9, 2023
(86) PCT No.: PCT/US2023/076395

§ 371 Date: May 2, 2025

Related U.S. Application Data
(60) Provisional application No. 63/422,348, filed on Nov. 3, 2022.

(51) Int. Cl. H04W 36/00; H04W 24/10; H04W 84/06

(52) U.S. Cl. CPC H04W 36/0058; H04W 24/10; H04W 84/06

(57) ABSTRACT

Methods and apparatuses used in a communication network are disclosed to implement enhanced UAV measurement reports. In one example embodiment, a method for an uncrewed aerial vehicle (UAV) connected to a network through one or more cells while in movement relative to the one or more cells is disclosed that: determines an event for one or more cells; and reports a cell ID of the one or more cells associated with the event without measurement data to the network.

### FIELD OF INVENTION

This invention relates generally to the field of wireless communication, and more particularly, to methods and apparatuses used in a communication network to implement enhanced UAV measurement reports.

### BACKGROUND OF THE INVENTION

In a wireless communications network, a user equipment (UE) may communicate with a base station of the network by establishing a radio link between the UE and the base station. In a 5G (New Radio or NR) or 4G (LTE) wireless network, a UE may receive signaling and data from the serving base station in a downlink transmission direction or transmit signaling and data to the serving base station in an uplink transmission direction.

An unmanned aerial vehicle (UAV), commonly known as a drone, is a particular type of user equipment (UE), that acts as an aircraft without any human pilot, crew, or passengers on board. UAVs may operate under remote control by a human operator, as remotely-piloted aircraft, or with various degrees of autonomy, such as autopilot assistance, up to fully autonomous aircraft that have no provision for human intervention. In particular, UAVs or UEs, especially those that are fully autonomous, need to continuously update the network through base stations or cells (base stations and cells being equivalent) with measurement reports.

A problem is that with prior art implementations of UAVs, the prior art implementations utilize a ReportOnLeave implementation, in which, the UAVs update measurement reports when every cell meets the leaving condition. This causes a huge signaling overhead reported back to the cells and the network. As an example, in prior art implementations, when a UAV moves from a first height to a second heigh, measurement reports for various cells need to be reported back to network. These measurement results include: Reference Signal Received Power (RSRP), Reference Signal Received Quality (RSRQ), Signal to Interference plus Noise Ratio (SINR) and beam reports, which is a huge signaling overhead that is required to be reported back to network.

It would be beneficial to implement a method to allow a UAV to provide to the network enhanced UAV measurement report with more concise and better regulated measurement reports.

### SUMMARY OF THE DESCRIPTION

Methods and apparatuses are disclosed for use in a communication network to implement enhanced UAV measurement reports. In one example embodiment, a method for an uncrewed aerial vehicle (UAV) connected to a network through one or more cells while in movement relative to the one or more cells is disclosed that includes: determining an event for one or more cells; and reporting a cell ID of the one or more cells associated with the event without measurement data to the network. In one embodiment, the event is at least one of an A3, A4, or A5 event. In one embodiment, the event is at least one of a B1 or B2 event.

In another example embodiment, a method for an uncrewed aerial vehicle (UAV) connected to a network through one or more cells while in movement relative to the one or more cells is disclosed that that includes: determining at a first time interval one or more cells in communication with the UAV; determining at a second time interval one or more cells in communication with the UAV; and determining, at the second time interval, a triggering event for one or more cells in communication with the UAV. In one embodiment, the triggering event comprises a predefined number of cells. In one embodiment, when the UAV moves relative to the one or more cells, from the first time interval to the second time interval, and at the second time interval a newly determined number of cells meets or exceeds the predefined number of cells, a report on change command is issued that includes transmitting measurement data for the cells of the one or more cells at the second time interval. In one embodiment, the predefined number is at least one.

In another example embodiment, a method for an uncrewed aerial vehicle (UAV) connected to a network through one or more cells while in movement relative to the one or more cells to initiate a measurement report is disclosed that includes: configuring a numberOfTriggeringCells for each MO (measurement object) associated with only one event, wherein, when the numberOfTriggeringCells for each MO are more than or equal to a setting, a measurement report is initiated. In one embodiment, the numberOfTriggeringCells configured by the network is a total number of cells meeting the events on one MO.

In a further example embodiment, a method for an uncrewed aerial vehicle (UAV) connected to a network through one or more cells while in movement relative to the one or more cells to initiate a measurement report is disclosed that includes: configuring a Total numberOfTriggeringCells for a first event for a MO and a second event for a MO, wherein, the UAV sums up the numberOFTriggering cells meeting the event on the two frequencies together, and if the total number is larger than or equal to the Total numberOFTriggering cells, a measurement report is initiated.

In another example embodiment, an uncrewed aerial vehicle (UAV) connected to a network through one or more cells while in movement relative to the one or more cells is disclosed that includes: at least one antenna; at least one radio, wherein the at least one radio is configured to communicate with the network including a cell using the at least one antenna; and at least one processor coupled to the at least one radio. The at least one processor is configured to perform operations comprising: determining an event for one or more cells; and transmitting a cell ID of the one or more cells associated with the event without measurement data to the network. In one embodiment, the event is at least one of an A3, A4, or A5 event. In one embodiment, the event is at least one of a B1 or B2 event.

In another example embodiment, an uncrewed aerial vehicle (UAV) connected to a network through one or more cells while in movement relative to the one or more cells is disclosed that includes: at least one antenna; at least one radio, wherein the at least one radio is configured to communicate with the network including a cell using the at least one antenna; and at least one processor coupled to the at least one radio. The at least one processor is configured to perform operations comprising: determining at a first time interval one or more cells in communication with the UAV; determining at a second time interval one or more cells in communication with the UAV; and determining, at the second time interval, a triggering event for one or more cells in communication with the UAV. In one embodiment, the triggering event comprises a predefined number of cells. In one embodiment, when the UAV moves relative to the one or more cells, from the first time interval to the second time interval, and at the second time interval a newly determined number of cells meets or exceeds the predefined number of cells, a report on change command is issued that includes transmitting measurement data for the cells of the one or more cells at the second time interval. In one embodiment, the predefined number is at least one.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6 is diagram illustrating an environment in which a UAV connects to a plurality of cells and to a network while in movement relative to the cells according to one embodiment of the disclosure.

FIG. 7 is a flow diagram illustrating reporting cell IDs according to one embodiment of the disclosure.

FIG. 8 is a flow diagram illustrating a measurement data reporting process according to one embodiment of the disclosure.

FIG. 9 is a diagram illustrating first and second solutions to the numberOfTriggeringCells for initiating measurement reports according to one embodiment of the disclosure.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

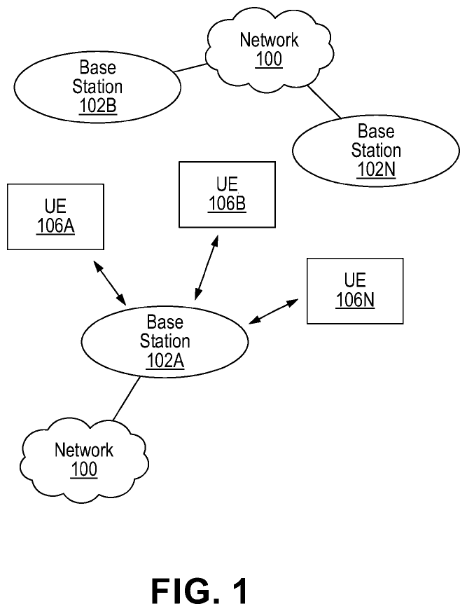

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

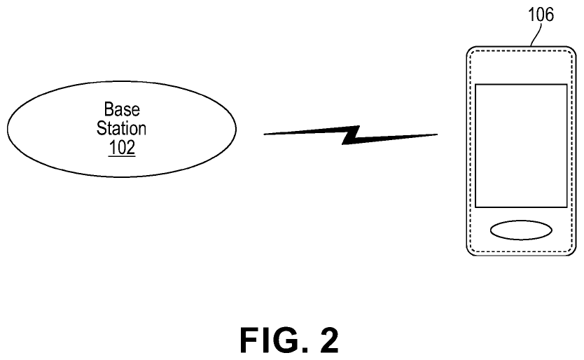

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

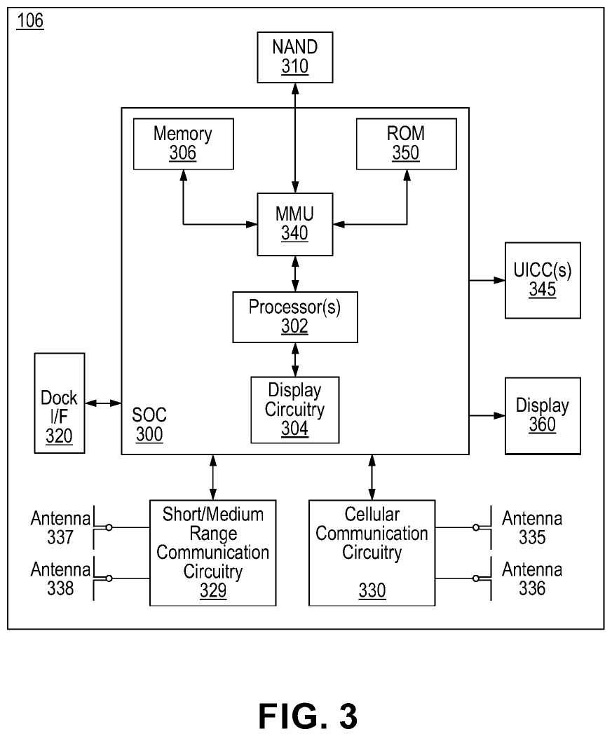

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

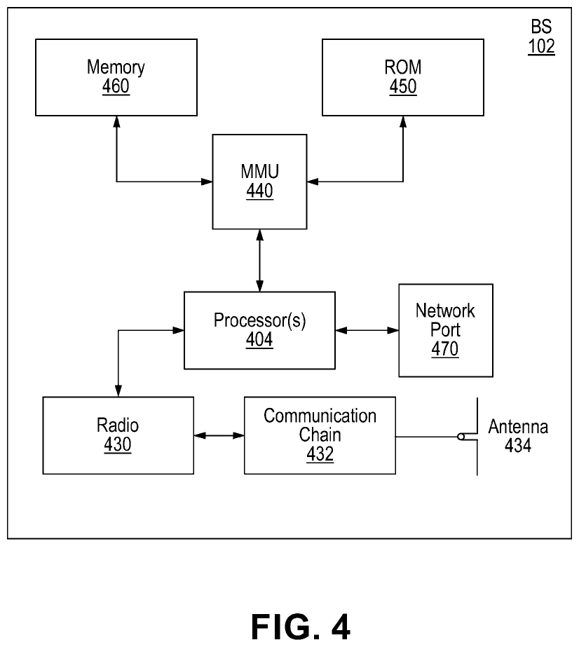

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

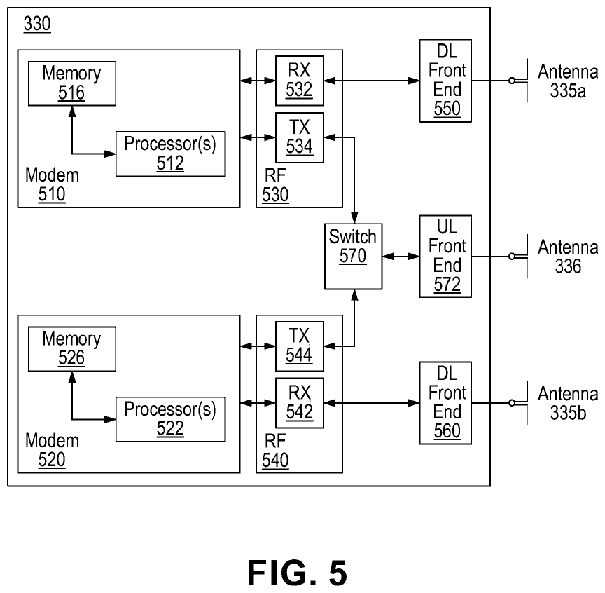

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

### UAV Environment

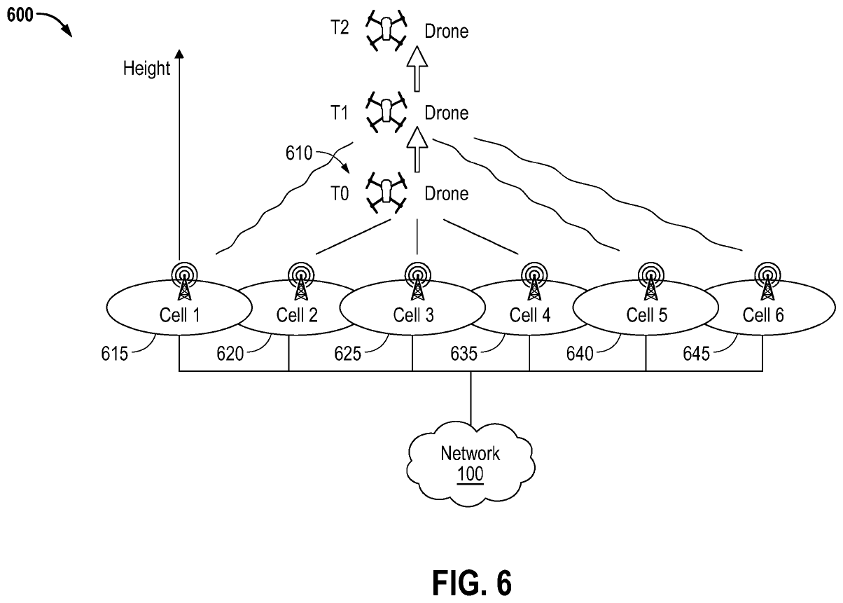

With reference to FIG. 6, an environment 600 in which an uncrewed aerial vehicle (UAVs) (e.g., sometimes referred to as Drones) connect to a plurality of cells (e.g., base stations 102) and to a network 100 while in movement relative to the cells will be described.

In this example environment, a UAV 610 rises relative to the earth and may communicate with various cells. In this example environment, UAV 610 may communicate with cell 1 615, cell 2 620, cell 3 625, cell 4 635, cell 5 640, and cell 6 645, at various time intervals T0, T1, and T2 and all the cells may be in communication with the network 100. Each cell is the equivalent of a base station (102A, 102B . . . 102N), the structure and functions, previously described in detail, and the UAV is the equivalent of a UE 106, the structure and functions, previously described in detail.

For example, at time (T0), as UAV 610 rises, UAV 610 can communicate with cell 2 620, cell 3 625, and cell 4 635. As UAV 610 rises further at time (T1), UAV 610 can communication with all the cells—cell 1 615, cell 2 620, cell 3 625, cell 4 635, cell 5 640, and cell 6 645. As UAV 610 rises even further at time (T2), UAV 610 can communication with only cells—cell 1 615, cell 5 640, and cell 6 645.

A problem with prior art implementations, is that prior art implementations utilize a ReportOnLeave implementation, in which, the UAV updates measurement reports when every cell meets the leaving condition. This causes a huge signaling overhead reported back to the cells and the network. As an example, in prior art implementations, when a UAV moves from T1 to T2, measurement report for cells 2, 3, and 4 (620, 625, 635) need to be reported back to network 100. These measurement results include: Reference Signal Received Power (RSRP), Reference Signal Received Quality (RSRQ), Signal to Interference plus Noise Ratio (SINR) and beam reports, which is a huge signaling overhead that is required to be reported back to network.

### Solution 1 Embodiment

In one embodiment of the invention, measurement results are not reported, which reduces signaling overhead. In one embodiment, the network 100 indicates cell report ID only and the UAV 610 only reports cell ID without carrying the measurement report. As will be described, the UAV 610 only reports the cell ID which meets an event (e.g., A3, A4, A5, B1, B2, etc.) In one embodiment, the network 100 can command that the UAV 610 report only the cell IDs without carrying measurement results for each cell. In this embodiment, network 100 can explicitly request that UAV 610 skips the detailed reporting of RSRP, RSRQ, SINR, and beam related reporting, and the UAV 610 only reports the cell ID based upon an event occurring.

For example, these events may include: Event A3 (Neighbour becomes offset better than serving cell (SpCell)); Event A4 (Neighbour becomes better than threshold); Event A5 (SpCell becomes worse than threshold1 and neighbour becomes better than threshold2); Event B1 (Inter-RAT neighbour becomes better than threshold); or Event B2 (primary cell (PCell) becomes worse than threshold1 and inter RAT neighbour becomes better than threshold2). Configuration may be done via RRC signaling. Reporting may be done via RRC signaling.

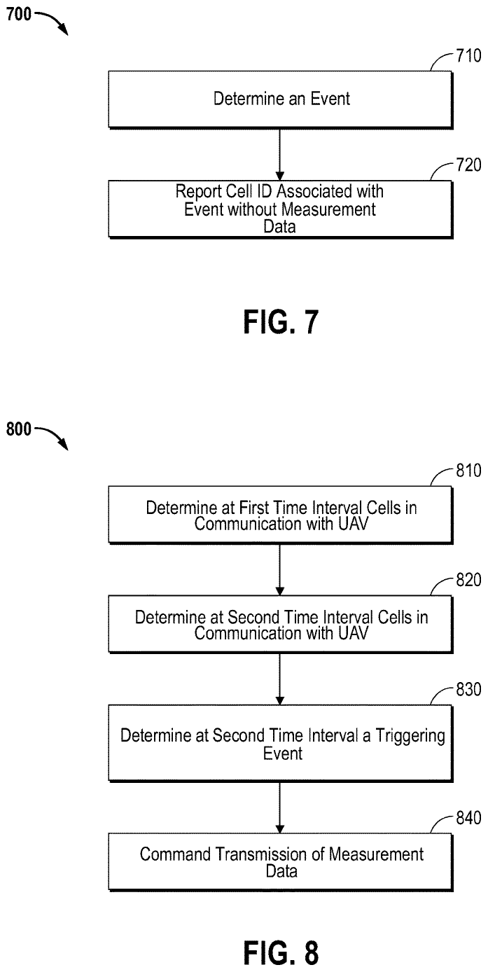

With brief additional reference to FIG. 7, a flow diagram is illustrated. At block 710, an event is determined. At block 720, a cell ID for determined cells is reported to the network 100, without measurement data.

As an illustration of this solution, with reference to FIG. 6, when an event occurs for a UAV 610 and the cell (e.g., A3, A4, A5, B1, B2), only the cell IDs for the determined cell is reported to the network 100, without measurement data. By only reporting the cell IDs instead of all the measurement data, the amount of signaling overhead that is reported back to network 100, is significantly reduced.

As a particular example, when UAV 610 moves to T0, A4 events may occur for cell 2 620 and cell 4 635 (e.g., these cells exceed threshold), and when this occurs, the Cell IDs for these cells (cell 2 and cell 4) may be reported to the network 100, without measurement data.

Of course, this is just one example. It should be appreciated that any event or combination of events (A3, A4, A5, B1, B2) for a UAV 610 and the cell may occur, and based on the event, only the cell IDs for the determined cell are reported to the network 100, without measurement data. And by only reporting the cell IDs instead of all the measurement data, the amount of signaling overhead that is reported back to network 100, is significantly reduced.

In this embodiment, network 100 can explicitly request that UAV 610 skips the detailed reporting of RSRP, RSRQ, SINR, and beam related reporting, and the UAV 610 only reports the cell ID to the network 100 based upon an event occuring.

### Solution 2 Embodiment

In one embodiment, a new reporting trigger is implemented. This new reporting trigger may be a ReportOnChange.

In one embodiment, the network 100 indicates a changed cell number threshold upon which the UE/UAV 610 can trigger the update. This could be a number in between 1 and a numberOfTriggeringCells (e.g, 1,half, numberOfTriggeringCells). The NumberOfTriggeringCells indicate the number of cells detected that are required to fulfill an event for a measurement report to be triggered. This field may be set for the events concerning neighbor cells (e.g., eventA3, eventA4, eventA5). As to UE behavior, the UE updates the cell list reported when a certain number (one or more) of cells get changed.

With reference FIG. 8, a process 800 in a flow diagram is used illustrate the Report on Change process. At block 810, the process determines at a first time interval, one or more cells in communication with the UAV. At block 820, the process determines, at a second time interval, one or more cells in communication with the UAV. At block 830, the process determines, at the second time interval, a triggering event for one or more cells in communication with the UAV. At block 840, the process commands transmission of measurement data. The triggering event may be a predefined number of cells. As an example, when the UAV moves relative to the one or more cells, from the first time interval to the second time interval, and at the second time interval a newly determined number of cells meets or exceeds the predefined number of cells, a report on change command is issued, comprising, transmitting measurement data for the cells of the one or more cells at the second time interval. The predefined number is at least one.

An example, of the Report On Change process will be illustrated with reference to FIG. 6. As an example, UAV 610 moves from a first time interval T1 (where it is communication with all the cells (cell 1 615, cell 2 620, cell 3 625, cell 4 635, cell 5 640, and cell 6 645) to a second time interval T2 where it is in communication with—cell 1 615, cell 5 640, and cell 6 645. At the second time interval (T2), if the newly determined number of cells meets or exceeds the threshold/predefined number of cells, a report on change command is issued, that includes transmitting measurement data for the cells of the one or more cells at the second time interval. Therefore, in this example, if the threshold/predefined number of cells is set at 2, all the measurement data for the cells—cell 1 615, cell 5 640, and cell 6 645, will be reported to the network 100.

However, if the threshold/predefined number of cells is set at 4, such that the threshold/predefined number of cells is not met, then the measurement data for the cells—cell 1 615, cell 5 640, and cell 6 645, will not be reported to the network 100.

In this way, the amount of measurement data that needs to be reported to the network 660 (that can include a lot signaling overhead), can be controlled by setting these thresholds. This is important due to the number of cells that the UAV 610 can be in communication with.

Also, in some embodiments, the numberOfTriggeringCells may be introduced to events B1/B2 (LTE measurements). As previously described, Event B1 refers to—Inter-RAT neighbour becomes better than threshold; and Event B2 refers to—primary cell (PCell) becomes worse than threshold1 and inter RAT neighbour becomes better than threshold2. Therefore, this solution may work together with the previously described solution. In this solution, the triggering configuration is independent from the NR report and LTE report.

### Solution 3 Embodiment

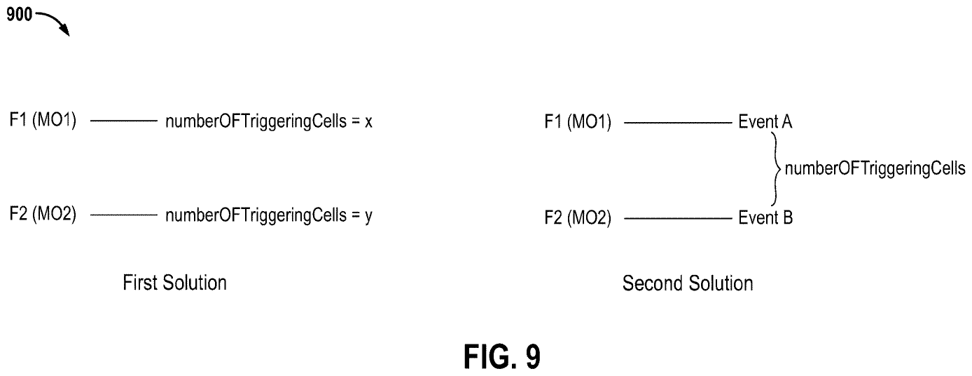

With reference to FIG. 9, FIG. 9 is a diagram illustrating first and second solutions to the numberOfTriggeringCells for initiating measurement reports.

FIG. 9 illustrates a first solution for a LTE UAV in which, the numberOfTriggeringCells are configured for each MO (measurement object) and only associated with one event. For example, the network 100 may configure two MO(s) on two frequencies:
MO1 (Frequency 1): measurement report event is A3, numberOfTriggeringCells is 5
MO1 (Frequency 1): measurement report event is A4, numberOfTriggeringCells is 6
MO2 (Frequency 2): measurement report event is A4, numberOfTriggeringCells is 3

Therefore, the neighbor cells meeting A3 on Frequency 1 should be more than (equal to) 5 for the UE/UAV 610 to initiate a measurement report. Similarly, the neighbor cells meeting A4 on Frequency 1 should be more than (equal to) 6 for UE to initiate a measurement report. As well, the neighbor cells meeting A4 on Frequency 2 should be more than (equal to) 3 for UE to initiate a measurement report.

In one embodiment, in a combined on single frequency first solution: The numberOfTriggeringCells configured by network 100 is a total number of cells meeting the events on one MO. For example, network 100 configures an Updated numberOfTriggeringCells as 6, and UE/UAV 610 can sum up the cells meeting A3 and A4 events on Frequency 1. When the total number of cells are more than (equal to) 6, UE/UAV 610 can trigger the measurement report.

In another second solution embodiment, the functions are combined on multiple frequencies. In this case, network 100 configures a Total numberOfTriggeringCells as, for example, 7 for MO1(with event A3) (Event A) and MO2 (with event A3) (Event B) (only an example, can be more frequencies). Then UE sums up the cells meeting event A3 on two frequencies together (numberOFTriggeringCells). If the total number is larger than (or equal to) 7, UE/UAV 610 triggers the measurement report.

The previously described methods performed by the UAV, cells, and network allow the UAV to provide to the network enhanced UAV measurement reports with more concise and better regulated measurement reports than in prior implementations, significantly reducing the huge signaling overhead performed by prior implementations.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the described operations may be stored as instructions on a non-transitory computer readable medium for execution by a computer. For example, the described operations may be stored as instructions on a non-transitory computer readable medium for execution by a computer. The computer (e.g., UAV, UE, base station, cell, network, etc.) may execute the instructions to perform the previously described operations.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMS, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A method for an uncrewed aerial vehicle (UAV) connected to a network through one or more cells while in movement relative to the one or more cells comprising:
determining an event for one or more cells; and
reporting a cell ID of the one or more cells associated with the event without measurement data to the network.

2. The method of claim 1, wherein the event is at least one of an A3, A4, or A5 event.

3. The method of claim 1, wherein the event is at least one of a B1 or B2 event.

4. A method for an uncrewed aerial vehicle (UAV) connected to a network through one or more cells while in movement relative to the one or more cells comprising:
determining at a first time interval one or more cells in communication with the UAV;
determining at a second time interval one or more cells in communication with the UAV; and
determining, at the second time interval, a triggering event for one or more cells in communication with the UAV.

5. The method of claim 4, wherein the triggering event comprises a predefined number of cells.

6. The method of claim 5, wherein, when the UAV moves relative to the one or more cells, from the first time interval to the second time interval, and at the second time interval a newly determined number of cells meets or exceeds the predefined number of cells, a report on change command is issued, comprising, transmitting measurement data for the cells of the one or more cells at the second time interval.

7. The method of claim 5, wherein, the predefined number is at least one.

8. A method for an uncrewed aerial vehicle (UAV) connected to a network through one or more cells while in movement relative to the one or more cells to initiate a measurement report comprising:
configuring a numberOfTriggeringCells for each MO (measurement object) associated with only one event,
wherein, when the numberOfTriggeringCells for each MO are more than or equal to a setting, a measurement report is initiated.

9. The method of claim 8, wherein, the numberOfTriggeringCells configured by the network is a total number of cells meeting the events on one MO.

10. A method for an uncrewed aerial vehicle (UAV) connected to a network through one or more cells while in movement relative to the one or more cells to initiate a measurement report comprising:
configuring a Total numberOfTriggeringCells for a first event for a MO and a second event for a MO,
wherein, the UAV sums up a numberOfTriggeringCells meeting the events on the two frequencies together to determine a total number, and if the total number is larger than or equal to the Total numberOfTriggeringCells, a measurement report is initiated.

11. An uncrewed aerial vehicle (UAV) connected to a network through one or more cells while in movement relative to the one or more cells, wherein the UAV is configured to perform the method of claim 1.

12. The UAV of claim 11, wherein the event is at least one of an A3, A4, or A5 event.

13. The UAV of claim 11, wherein the event is at least one of a B1 or B2 event.

14. An uncrewed aerial vehicle (UAV) connected to a network through one or more cells while in movement relative to the one or more cells, wherein the UAV is configured to perform the method of claim 4.

15. The UAV of claim 14, wherein the triggering event comprises a predefined number of cells.

16. The UAV of claim 15, wherein, when the UAV moves relative to the one or more cells, from the first time interval to the second time interval, and at the second time interval a newly determined number of cells meets or exceeds the predefined number of cells, a report on change command is issued, comprising, transmitting measurement data for the cells of the one or more cells at the second time interval.

17. The UAV of claim 15, wherein, the predefined number is at least one.
